(19) United States
(12) Patent Application Publication
(10) Pub. No.: US 2012/0319002 A1
(43) Pub. Date: Dec. 20, 2012

(54) ION GENERATING APPARATUS

(76) Inventors: Yoshifumi Yamamoto, Osaka-shi (JP); Yoshihiro Uramoto, Osaka-shi (JP)

(21) Appl. No.: 13/579,601

(22) PCT Filed: Jan. 14, 2011
(86) PCT No.: PCT/JP2011/050516

§ 371 Date: Aug. 17, 2012

(30) Foreign Application Priority Data
Jun. 9, 2010 (JP) 2010-131846

(51) Int. Cl. H01J 27/02; H01J 3/14

(52) U.S. Cl. 250/398; 250/423 R

(57) ABSTRACT

Disclosed is an ion generating apparatus including a housing that is configured to be capable of specifically setting the positional relationship between the ion generating apparatus and an object from which adhering odors are to be removed. The ion generating apparatus is capable of directionally emitting ions toward the object.

### TECHNICAL FIELD

The present invention relates to an ion generating apparatus that releases ions, which are generated by an ion generating device, together with air blown out by a blower.

### BACKGROUND ART

Bacteria such as Serratia and Bacillus, viruses, and the like are suspended in the air in inhabited spaces and inhabited rooms of, for example, homes, offices, schools, and hospitals. Moreover, various odors exist in spaces where people live. In order to remove bacteria, odors, and the like, an air conditioner for purifying indoor air is often disposed in a room of general homes.

For example, air conditioners described in Patent Literatures 1 and 2 include an ion generating device generating positive ions H⁺(H₂O), and negative ions O₂⁻(H₂O)ₙ, and a blower releasing H⁺(H₂O)ₙ and O₂⁻(H₂O)ₙ generated by the ion generating device, into a room. The air conditioner simultaneously generates and releases H⁺(H₂O)ₙ and O₂⁻(H₂O)ₙ, which cause chemical reactions on surfaces of airborne bacteria and the like in the room, thereby generating hydroxyl radicals (.OH) or hydrogen peroxide H₂O₂, which is a reactive substance. Because hydroxyl radicals (.OH) and hydrogen peroxide H₂O₂ are highly reactive, they can decompose and sterilize airborne bacteria.

### CITATION LIST

### Patent Literature

PTL 1: Japanese Patent No. 3770784 (Japanese Unexamined Patent Application Publication No. 2002-78788)
PTL 2: Japanese Patent No. 4436877 (Japanese Unexamined Patent Application Publication No. 2010-55960)

### SUMMARY OF INVENTION

### Technical Problem

The intended use of the air conditioners described in Patent Literatures 1 and 2 is to sterilize and inactivate airborne bacteria, viruses, and the like in the air, however an effect of removing odors adhering to, for example, curtains or clothes hung on a hanger or the like can be only negligibly expected from these air conditioners. This is because the generated ions are dispersed around a room and therefore the number of ions that reach curtains and clothes hung on a hanger or the like is too small to remove adhering odors and to remove, sterilize, or inactivate bacteria.

Moreover, it has been very difficult to remove sweat odor and the like of, for example, a hat or a helmet, which are used in direct contact with human skin and a large amount of substances adhere to them.

For this reason, an apparatus has been desired with expectations that it is capable of, instead of emitting ions into a room for the purpose of purifying the air, emitting ions directionally toward an object, such as a hat or a helmet, for the purpose of effectively removing odors and sterilizing bacteria and the like adhering to the object.

However, the effect of removing bacteria and odors adhering to an object such as a hat or a helmet cannot be expected from the air conditioner and the ion generating apparatus described in Patent Literatures 1 and 2, which are used to purify air in an inhabited room space. To realize the effect of removing odors and bacteria, a user has to hold the hat or the helmet over an air outlet through which ions are released, and to keep such position for a long time. Even this may be ineffective if the object is not properly held.

An object of the present invention, which addresses the problem described above, is to provide an ion generating apparatus that is capable of specifically setting the positional relationship between an object and an air outlet of the ion generating apparatus and is capable of directionally emitting ions toward the object.

### Solution to Problem

To achieve the abovementioned object, an ion generating apparatus according to the present invention includes a housing that forms an exterior body, an air inlet through which air is sucked in, an air outlet through which the sucked-in air is blown out, a blower disposed between the air inlet and the air outlet and blowing the air, and an ion generating device that generates ions and sends them to the outside together with the air blown out by the blower, wherein the housing includes a positioning portion that is capable of specifically setting a positional relationship between the air outlet and an object toward which the ions are emitted. With this structure, the ion generating apparatus is capable of specifically setting the positional relationship between the air outlet of the ion generating apparatus and an object and is capable of directionally emitting ions toward the object.

Specifically, in the structure described above, the positioning portion may include a depression formed in an upper part of the housing so that it allows a part of the object to be placed thereon.

More specifically, in the structure described above, the positioning portion may include a recess that is recessed inward in a side wall of the housing so as to be capable of specifically setting the positional relationship with the object.

In the structure described above, an auxiliary air outlet may be formed in the recess. With this structure, when the object is, for example, a helmet, ions can be directionally released toward cheek pad sections of the helmet.

Furthermore, in the structure described above, the housing may include an installable hook portion for placing an accessory part of the object thereon. With this structure, when the object is, for example, a helmet, a chin strap of the helmet can be placed on the hook portion, and thereby the air outlet can be prevented from being blocked by the chin strap. Moreover, the chin strap can be effectively sterilized.

Also, in the structure described above, a heat source for heating the blown air may be disposed downwind of the blower and upwind of the ion generating device. With this structure, the effect of deodorizing and sterilizing an object can be achieved in a shorter time.

In the ion generating apparatus having the structure as described above, the positional relationship may be specifically set when the object is supported by the depression and a substantially flat placement surface in a situation in which the ion generating apparatus is placed on the substantially flat placement surface, and the air may be blown out through the air outlet toward the object for which the positional relationship has been specifically set. In this case, the object may be a helmet or a hat.

### Effects of Invention

The ion generating apparatus according to the present invention is capable of specifically setting the positional relationship between an air outlet of the ion generating apparatus and an object and is capable of directionally emitting ions toward the object.

### BRIEF DESCRIPTION OF DRAWINGS

FIG. 1 is an external side view of an ion generating apparatus according to an embodiment of the present invention.

FIG. 2 is an external top view of the ion generating apparatus according to the embodiment of the present invention.

FIG. 3 is a longitudinal sectional view illustrating the internal structure of the ion generating apparatus according to the embodiment of the present invention.

FIG. 4 is an external perspective view of the ion generating apparatus according to the embodiment of the present invention.

FIG. 5 is a top view of a specific example of an ion generating device according to an embodiment of the present invention.

FIG. 6 illustrates the ion generating apparatus according to the embodiment of the present invention in an example of a mode of use.

FIG. 7 illustrates the ion generating apparatus according to the embodiment of the present invention in a mode of use different from that of FIG. 6.

FIG. 8 illustrates the ion generating apparatus according to the embodiment of the present invention in another example of a mode of use.

FIG. 9 is an external side view of an ion generating apparatus according to another embodiment of the present invention.

FIG. 10 is a partially cut-away top view of the ion generating apparatus illustrated in FIG. 9.

FIG. 11 illustrates the ion generating apparatus according to the other embodiment of the present invention in an example of a mode of use.

FIG. 12 illustrates an ion generating apparatus according to another embodiment of the present invention, wherein part (a) is a sectional view of an installed state, and part (b) is a sectional view of a used state.

FIG. 13 illustrates the ion generating apparatus illustrated in FIG. 12 in a mode of use.

### DESCRIPTION OF EMBODIMENTS

### First Embodiment

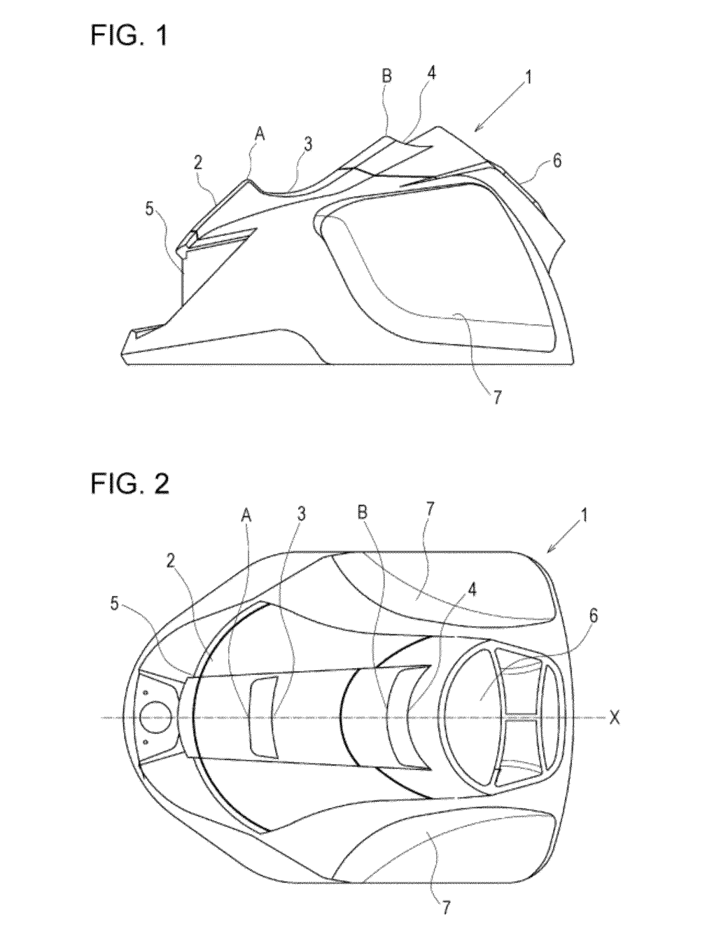

Hereinafter, an embodiment (a first embodiment) of the present invention will be described with reference to the drawings. FIG. 1 is an external side view of an ion generating apparatus according to the present embodiment,

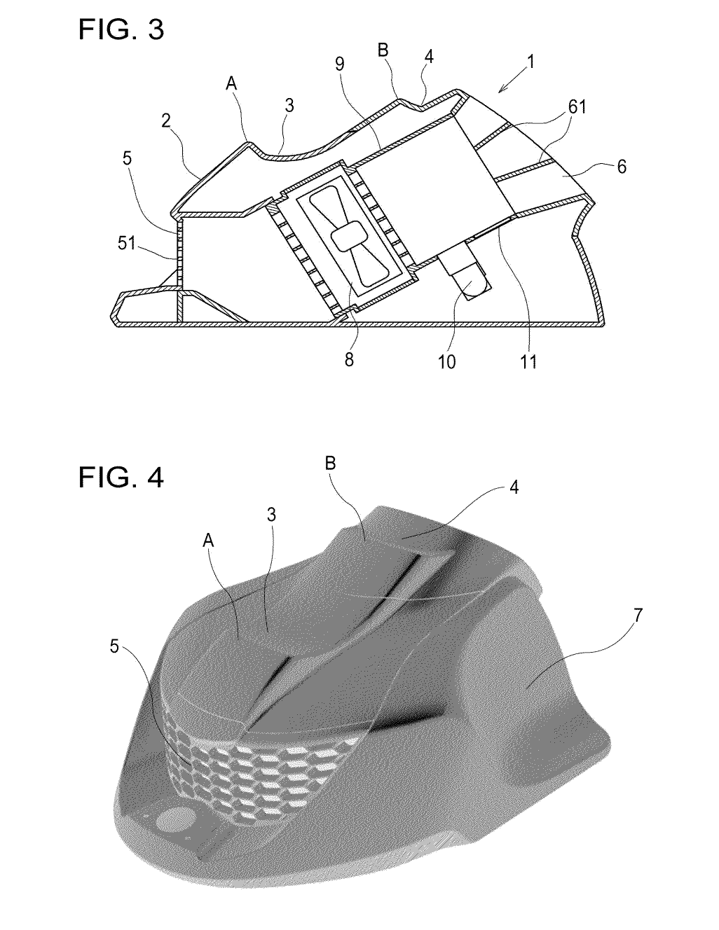

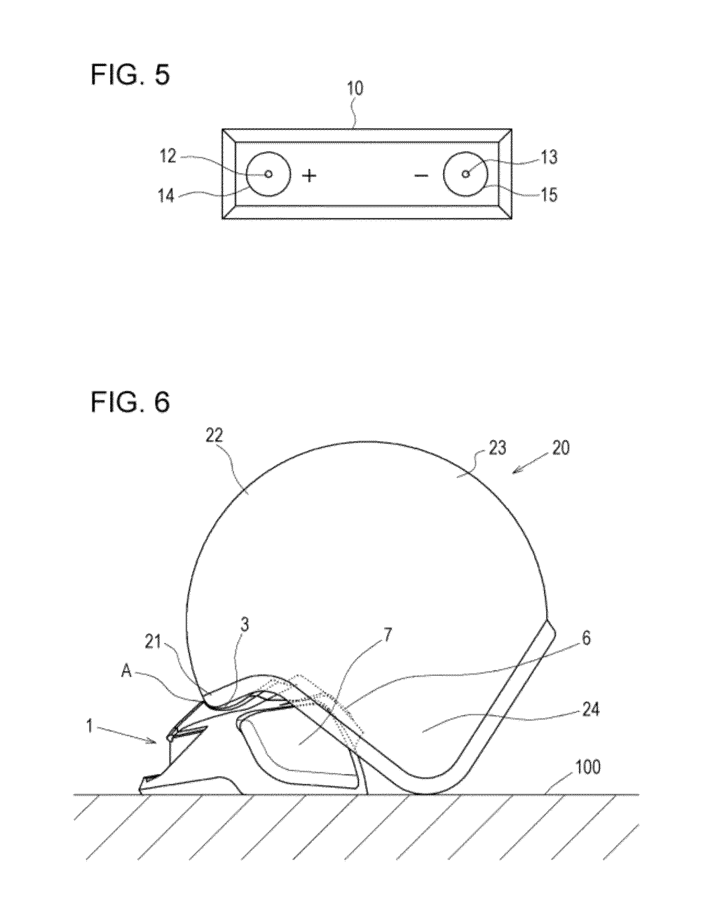

FIG. 2 is an external top view of the ion generating apparatus, FIG. 3 is a longitudinal sectional view illustrating the structure of the ion generating apparatus cut along a central line of FIG. 2, FIG. 4 is an external perspective view of the entirety of the ion generating apparatus, FIG. 5 is a top view of ion generators of an example of an ion generating device used in the present embodiment, and FIGS. 6 to 8 illustrate the ion generating apparatus according to the present embodiment in respective modes of use.

First, referring to FIG. 1, an ion generating apparatus 1 according to the present embodiment will be described. A housing 2 of the ion generating apparatus 1, which forms the outline of the body (exterior body) of the ion generating apparatus 1, is substantially wedge-shaped in side view. That is, the housing 2, which forms the outline of the body of the ion generating apparatus 1, is shaped such that an upper part thereof is gradually inclined upward from the left side (referred to as the front side) toward the right side (referred to as the rear side) in FIG. 1. A protrusion A, which is formed at a position along the inclined portion, can position a part of a helmet wearable by a person (an example of an object toward which ions are emitted), such as a forehead section or a chin section of the helmet, in accordance with the type of the helmet. Moreover, a protrusion B is formed at a position higher than that of the protrusion A in the direction of inclination. Being formed at a position between the protrusion A and the protrusion B, a depression 3 is substantially just behind the protrusion A. The depression 3, paired with the protrusion A, is included in a positioning portion (a portion that is capable of specifically setting the positional relationship between an object and the ion generating apparatus 1 (in particular, an air outlet 6 described below)). When the chin section or the forehead section of a helmet, which will be described below in detail, is placed on the depression 3, the depression 3 performs positioning so that the positional relationship between the helmet and the ion generating apparatus 1 is specifically set. Furthermore, a depression 4, which is one step lower than the protrusion B, is also formed at a position substantially just behind the protrusion B, functions and effects of which are similar to those of the depression 3.

As illustrated in FIG. 2, when the ion generating apparatus 1 is seen from above, the housing 2 has a substantially pentagonal appearance, the air inlet 5, through which air is sucked in, is formed on the front side of the ion generating apparatus 1 (the left side in FIG. 2), the air outlet 6, through which the sucked-in air is blown out, is formed on the rear side of the ion generating apparatus 1 (the right side in FIG. 2). As illustrated in FIG. 2, in both side walls of the housing 2 (the upper side and the lower side in FIG. 2), recessed portions are formed so as to be inwardly curved with a central plane X of the ion generating apparatus 1 therebetween (hereinafter, these portions in the both side walls will be collectively referred to as “recesses 7”). A part of the housing 2 that connects the protrusion A to the air outlet 6 is shaped like a mountain range. In particular, a line connecting the protrusion A and the protrusion B is shaped like a ridge of a mountain, wherein this ridge becomes a center and forms the housing 2 in a symmetrical shape to left and right.

The recesses 7, which are formed in the both side walls as described above, serve to avoid interference between the body of the ion generating apparatus 1 and side sections of the helmet (such as cheek pad sections) when, for example, the helmet is made to engage with the depression 3. The recesses 7 also serve to specifically set the positional relationship between the ion generating apparatus 1 and the helmet by coming into contact with parts of the helmet. The housing 2 of the body of the ion generating apparatus 1 has such an appearance that an upper part thereof is inclined gradually upward relative to a bottom surface toward, in particular, the air outlet 6, thereby forming a mountain-like shape. With such a shape, the bottom part is very stable and overturning can be prevented.

Next, referring to FIG. 3, the internal structure of the ion generating apparatus 1 will be described in detail. In FIG. 3, the air inlet 5 and the air outlet 6 are formed on the front side and the rear side of the housing 2 as described above, wherein a blower 8, which includes a fan, a motor, and other components, and an air duct 9 are disposed in an air passage that extends along a substantially straight line connecting the air inlet 5 to the air outlet 6. The air duct 9 extends so as to connect the blower 8 to the air outlet 6. An ion generating device 10, which has an ion generator exposed to the inside of the air duct 9, is disposed in the air duct 9. Also, an ion detector 11 for detecting generated ions is disposed downwind of the ion generating device 10. The ion detector 11 detects ions generated by the ion generating device 10 and monitors the state of generated ions. When ions are not detected or the number of generated ions is small, the body of the ion generating apparatus 1 displays or sounds an alarm.

A grid 61 for preventing insertion of a finger or other foreign objects from the outside is disposed in the air outlet 6. Also, a mesh 51 for preventing entry of foreign objects to the inside is disposed in the air inlet 5. The mesh 51 is made from a perforated metal plate, a wire gauze, or the like.

As illustrated in FIG. 3, the ion generating device 10 is disposed in the air duct 9 such that an ion generating surface thereof faces a flat lower wall of the air duct 9. The ion detector 11 is disposed near the ion generating device 10 so as to be flush with the above mentioned wall surface of the air duct 9.

Thus, as the blower 8 takes in air through the air inlet 5, the ions generated by the ion generating device 10 are carried by the air when the air passes through the air duct 9, and the ions are released through the air outlet 6 together with the air. As illustrated in FIG. 3, the air sucked in from a lower part area of the housing 2 of the body of the ion generating apparatus 1 passes through the air duct 9, which extends in an upwardly inclined direction in accordance with the shape of the housing, and is released obliquely upward through the air outlet 6. Similarly, ions can be efficiently released due to the upwardly inclined and substantially linear air passage with no obstacles in the air passage.

Moreover, because the blower 8 is disposed so as to face the air inlet 5 at a position lower than and farther forward than substantially the center of the housing 2, the center of gravity of the ion generating apparatus 1 is nearer to the bottom surface. As a result, the body of the ion generating apparatus 1 is stable when being placed and overturning prevention can be effectively provided. Also due to the shape of the housing 2 described above, which is, in particular, a substantially pentagonal and mountain-like shape, the body of the ion generating apparatus 1 can be stably placed, and thereby problems of overturning and the like can be resolved.

FIG. 5 illustrates a specific example of the ion generating device 10 disposed in the air duct 9, where ion generating device 10 includes a positive ion generator 12 and a negative ion generator 13, which are independent from each other. The two ion generators 12 and 13 are disposed separate from each other such that the direction of a straight line connecting the ion generators 12 and 13 intersects the direction of airflow created by the blower 8.

The ion generating device 10 includes a power supply (not shown) and a holder (not shown). The power supply supplies voltages to the two ion generators, which are the positive ion generator 12 and the negative ion generator 13. The holder holds the ion generators and the power supply. The power supply supplies a positive high voltage and a negative high voltage to discharge electrodes 14 and 15 of the ion generators 12 and 13, respectively. According to this, the ion generators 12 and 13 cause corona discharge and generate ions.

In the present embodiment, the ion generators of the ion generating device 10 are needle electrode ion generators which include the discharge electrodes 14 and 15 that are needle electrodes, and induction electrodes that annularly surround the needle electrodes. Instead of such an ion generator structure, a planar electrode ion generator formed by printing a discharge electrode on an insulating substrate, can be also used. When using a planar electrode ion generator having a single discharge electrode, the direction of the electrode and the direction of airflow may be parallel to each other or intersect each other. However, when using a planer electrode ion generator having independent electrodes that respectively generate positive ions and negative ions, it is preferable that the electrodes be disposed separate from each other in a direction that intersects the direction of airflow as in the case of the needle electrode ion generators described above, because the number of discharged ions is increased by doing so. To generate positive and negative ions by using a single discharge electrode, a positive and a negative high voltage are alternately supplied to the discharge electrode.

The ion generating device 10 used in the present embodiment has two ion generators: the ion generator 12, which emits positive ions H⁺(H₂O)ₘ (where m is any integer) into the air, and the ion generator 13, which emits negative ions O₂⁻(H₂O)ₙ (where n is any integer) into the air. The generated ions adhere to an object and cause a chemical reaction in which OH radicals and/or hydrogen peroxide H₂O₂ is generated, thereby producing an effect of sterilization and deodorization. The higher the concentration of generated positive and negative ions, the greater the effect. Because the generated positive and negative ions have a property of recombining with each other and disappearing, even if the concentration of the generated ions is high in the vicinity of the ion generating device 10, the concentration sharply decreases with increasing the distance the ions travel.

For this purpose, the generated positive and negative ions need to reach a target object and perform deodorization and sterilization as described above before the positive and negative ions recombine with each other and disappear. Therefore, it is necessary to efficiently release the ions, which are generated by the ion generating device 10, through the air outlet 6 so that the ions can reach the target object. As illustrated in FIG. 3, in the ion generating apparatus 1 according to the present embodiment, the air duct 9 including the blower 8 is short and extends substantially linearly toward the air outlet 6, resulting in the capability of the ion generating apparatus 1 of efficiently releasing generated ions through the air outlet 6 while suppressing recombination of ions, and thus enabling delivery of a large number of ions to a target object.

The air duct 9 of the ion generating apparatus 1 illustrated in FIGS. 1 to 3 is substantially linear and short, so that the size of the entire apparatus can be reduced and the ion generating apparatus 1 can release ions through the air outlet 6 while maximally suppressing recombination of generated ions. Therefore, the body of the ion generating apparatus 1 can be easily carried to and disposed in any room. Moreover, the ion generating apparatus 1 can be placed in the vicinity of a target object and can efficiently and directionally emit ions toward the object. When carried to and disposed in any place, the ion generating apparatus 1 does not overturn and can be used in a stable state.

Additionally, the ion generating apparatus 1 according to the present embodiment is configured such that ions generated by the ion generating device 10 can be directionally released toward a helmet, the target object, so the ion generating apparatus 1 can be used not only to deodorize and sterilize but also to dry the helmet. That is, the outer shape of the ion generating apparatus 1 is configured such that the ion generating device 10 is disposed in the vicinity of the air outlet 6 so that positive and negative ions can be generated as near as possible to the object forming the most preferable positional relationship between a helmet, an example of a target object, and the ion generating apparatus 1 (in particular, the air outlet 6) that can always be achieved.

Furthermore, the ion generating apparatus 1 according to the present embodiment can be stably placed regardless of whether an object is present. Besides, the ion generating apparatus 1 is configured such that the ion generating apparatus 1 can reliably maintain the positional relationship in a mode of use for deodorizing an object, removing and sterilizing bacteria, and drying of the object.

Referring to FIG. 6, an example of the mode of use will be described. FIG. 6 illustrates a helmet 20, the type that does not cover a face, placed on the ion generating apparatus 1 such that the mode of use described above can be maintained. The helmet 20 of this type is a simple helmet, which is usually called an open face helmet. The open face helmet 20 is shaped so as to cover and protect the head, the forehead of the face, the vertex of the head, the back of the head, the cheeks (both cheeks), and the chin of a person, however a part of the helmet 20 in front of the face is open. FIG. 6 shows sections of the helmet 20 corresponding to the forehead, the vertex of the head, the back of the head, the cheeks, and the chin of a person are respectively denoted by numerals as follows: a forehead section 21, a vertex section 22, a back-head section 23, and cheek pad sections 24.

First, the ion generating apparatus 1 is disposed (placed) on a placement surface 100 in a place of use. Here, it is assumed that the placement surface 100 is substantially flat. The forehead section 21 of the open face helmet 20 is placed on the depression 3, which is paired with the protrusion A, of the ion generating apparatus 1 placed on the placement surface 100. When the forehead section 21 is placed on the depression 3, a part of the helmet 20 engages with the depression 3, and the position of the helmet 20 is restrained by the protrusion A. Corners of the cheek pad sections 24 on both sides of the helmet 20 are placed on the placement surface 100, and the helmet 20 is maintained (restrained) while being positioned. Thus, the helmet 20 is supported by the depression 3 and the placement surface 100 while the ion generating apparatus 1 is placed on the placement surface 100, and thereby the positional relationship between the helmet 20 and the ion generating apparatus 1 (in particular, the air outlet 6) is specifically set.

The cheek pad sections 24 on both sides of the helmet 20 correspond to the recesses 7, which are located on both sides of the ion generating apparatus 1 and have curved shapes, so that positioning can be reliably performed as parts of the helmet are in contact with the recesses 7. At this time, the positional relationship between the helmet 20 and the ion generating apparatus 1 (in particular, the air outlet 6) is specifically set, and the helmet 20 is placed while being positioned in this way. Also, for the recesses 7 are formed on both sides of the ion generating apparatus 1, positioning described above can be reliably performed without obstructing placement of the helmet 20. The helmet 20 is placed while maintaining a specific positional relationship with the ion generating apparatus 1 such that a part of the ion generating apparatus 1 between the recesses (between both side walls) is disposed between both sides of the helmet 20.

When the helmet 20 is placed on the ion generating apparatus 1 as described above, the ion generating apparatus 1 is disposed between both sides of the helmet 20 with the air outlet 6 in the middle. When the ion generating apparatus 1 is operated in this state, positive and negative ions are released through the air outlet 6 together with air blown by the blower 8 and are directly and straightly released toward the inside of the back-head section 23 and the vertex section 22 of the helmet 20. Then, the released ions spread throughout the inner space of the helmet 20 and adhere everywhere in the helmet 20. At this time, the concentration of each of the positive and negative ions inside, i.e., in the inner space of the helmet 20, becomes several million/cm³, which is 100 to 1000 times higher than a concentration that can be achieved in an indoor environment by using an ordinary air conditioner comprising an ion generating device. Thus, a super-high-concentration ion space unachieved in conventional circumstances can be created, and thereby odors of sweat and sebum adhering to the inner wall of the helmet 20 are decomposed and eliminated. At the same time, adhering bacteria and viruses and airborne bacteria can be efficiently sterilized and inactivated.

Additionally, not only is there an effect achieved by the ions, but also a drying effect can be simultaneously expected because moisture in the inner wall of the helmet 20 is removed by the air blown by the blower 8.

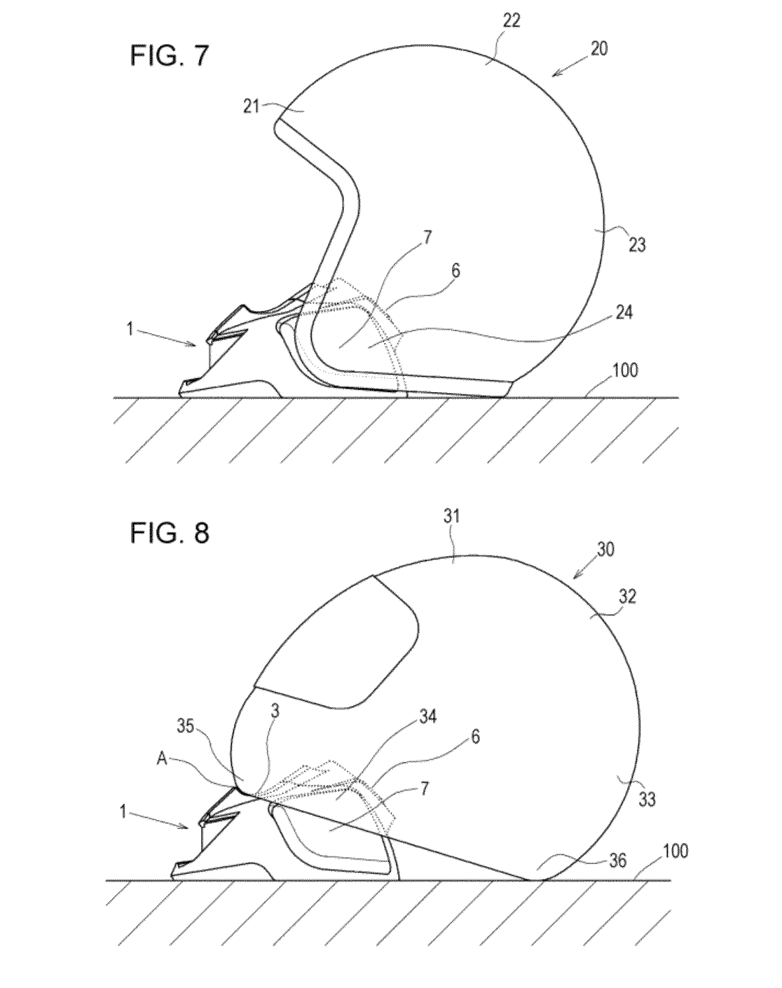

Here, the open face helmet 20 can be placed with respect to the ion generating apparatus 1 not only in the way illustrated in FIG. 6 but also, for example, in the way illustrated in FIG. 7. In this case, the helmet 20 is placed such that the cheek pad sections 24 of the helmet 20 correspond to the recesses 7 on both sides of the ion generating apparatus 1. The helmet 20 is positioned such that a part of the ion generating apparatus 1 between the recesses 7 is disposed between the cheek pad sections 24 on both sides. Even in this case, the positional relationship between the helmet 20 and the ion generating apparatus 1 can be specifically set by using the recesses 7.

In this state, a lower part of the back-head section 23 is in contact with and supported by the placement surface 100. In this state, the helmet 20 is placed in an upright position while being positioned with respect to the ion generating apparatus 1.

The helmet 20 is supported while maintaining a specific positional relationship with the ion generating apparatus 1 in a state in which the front side of the helmet 20, i.e., a part corresponding to a face, is open. Next, a part of the inside of the helmet 20 between the vertex section 22 and the back-head section 23 faces the air outlet 6 of the ion generating apparatus 1, and ions are directionally emitted toward the part. Then, the ions spread throughout the inner space of the helmet, and the atmosphere in the helmet (the inner space) becomes a high concentration ion atmosphere as in the case illustrated in FIG. 6. Thus, an effect the same as that of in the case illustrated in FIG. 6 can be expected.

As described above, when the helmet 20 is placed as illustrated in FIG. 7, the recesses 7 serve as a positioning portion for positioning the helmet 20, which is an object. The recesses 7 are formed so as to follow the shapes of the cheek pad sections 24 of the open face (type) helmet 20 so that the recesses 7 can be in contact with and support parts of the cheek pad sections 24.

FIG. 8 illustrates a case where the ion generating apparatus 1 is used for a helmet 30, which is a type of helmet that covers the entirety of a face and is called a full face helmet. This type of a helmet 30 is formed so as to completely cover and protect a person's head, except for the lower part of the helmet 30 where it has an opening, through which a head is inserted. The ion generating apparatus 1 according to the present embodiment maintains a positional relationship with the helmet such that the air outlet 6 is inserted into the head insertion opening. Sections of the helmet 30 that correspond to parts of the head and the face of a person when the person wears the helmet 30 illustrated in FIG. 8 are denoted by numerals as follows: a forehead section 31, a vertex section 32, a back-head section 33, cheek pad sections 34, and a chin section 35.

The chin section 35 of the full face helmet 30 is placed on the depression 3, which is paired with the protrusion A, of the ion generating apparatus 1. When the chin section 35 of the helmet 30 is placed at a predetermined position, i.e., when placed on the depression 3, movement of the helmet 30 is restrained by the protrusion A as described above. Moreover, certain parts of the peripheral edge of the head insertion opening of the helmet 30 (the cheek pad sections 34) are brought into contact with the recesses 7 on both sides of the ion generating apparatus 1. Due to the presence of the recesses 7, when placing the helmet 30, the helmet 30 does not interfere with both side walls of the housing 2, and the helmet 30 can be positioned such that the air outlet 6 is located between both sides of the helmet 30. Also, when the chin section 35 of the helmet 30 is placed on the depression 3 and a lower portion 36 of the back-head section 33 is placed on the placement surface 100, on which the ion generating apparatus 1 is placed, the helmet 30 is restrained so as to have a specific positional relationship with the ion generating apparatus 1.

When the ion generating apparatus 1 is placed as described above and operated, positive and negative ions are released through the air outlet 6 together with air blown by the blower 8, and the ions collide with the vertex section 32 of the inside of the helmet 30, then the released ions spread to the back-head section 33 and throughout the inner space of the helmet 30 and adhere everywhere in the helmet 30. At this time, the concentration of each of the positive and negative ions in the inner space of the helmet 30 reaches several million/cm³, which is 100 to 1000 times higher than the concentration that can be achieved in an indoor environment by using an ordinary air conditioner comprising the ion generating device 10.

It was confirmed by experiments that, when positive and negative ions were emitted toward synthetic sweat odor with a concentration of 2 million/cm³ for approximately 4 hours, the odor intensity was reduced to about 1/100 that of the case where positive and negative ions were emitted with a concentration of 5 thousand/cm³ for about four hours. Naturally, in such a case, not only are odors eliminated but also bacteria and the like adhering to the inside of the helmet 30 or that are suspended in the inner space of the helmet 30 can be sterilized and viruses and the like can be inactivated. The higher the ion concentration, the greater the effect.

Not only is there an effect achieved by the ions but also a drying effect can be simultaneously achieved because moisture in the inner wall of the helmet 30 is removed by air that is blown by the blower 8.

As described above, examples of objects subjected to deodorization, sterilization, and the like performed by the ion generating apparatus 1 include various types of helmets for motorcycles (including mopeds) and bicycles. However, the object is not limited to these; it may be a batting helmet or the like, where the same effects can be expected in such a case. Besides, a hat (cap) may be used as an object as long as the hat can maintain its shape when it is placed. In particular, anything that does not lose its shape and maintains its form when being placed and that has an inner space can be used as an object.

When using a helmet, a hat, or the like having a shape different from those of the helmets 20 and 30 as an object, the outer shape of the housing of the ion generating apparatus 1 is to be formed so as to match the shape of the helmet, hat, or the like.

### Second Embodiment

Next, another embodiment (a second embodiment) of the present invention will be described. In the second embodiment, auxiliary air outlets are additionally formed in the recesses 7 of the ion generating apparatus 1 according to the first embodiment described above. Therefore, the structure of an ion generating apparatus 1 according to the second embodiment is basically the same as that of the ion generating apparatus 1 according to the first embodiment. The same parts will be denoted by the same numerals and description of such parts will be omitted.

As described above, the recesses 7 are formed in the side surfaces of the housing 2 of the ion generating apparatus 1 so as to correspond to the positions of the cheek pad sections of the helmet. The cheek pad sections are in close contact with the cheeks of a person when the helmet is worn by the person, and correspond to the recesses 7 when the helmet is placed on the ion generating apparatus 1. When the helmet is placed on the ion generating apparatus 1, certain parts of the helmet stay in contact with the recesses 7.

Therefore, the ion generating apparatus 1 according to the first embodiment cannot directly release ions toward the cheek pad sections. In this regard, the ion generating apparatus 1 according to the second embodiment is provided with the auxiliary air outlets so that ion can be directly emitted toward the cheek pad sections of the helmet. In other respects, the structure is the same as that of the first embodiment.

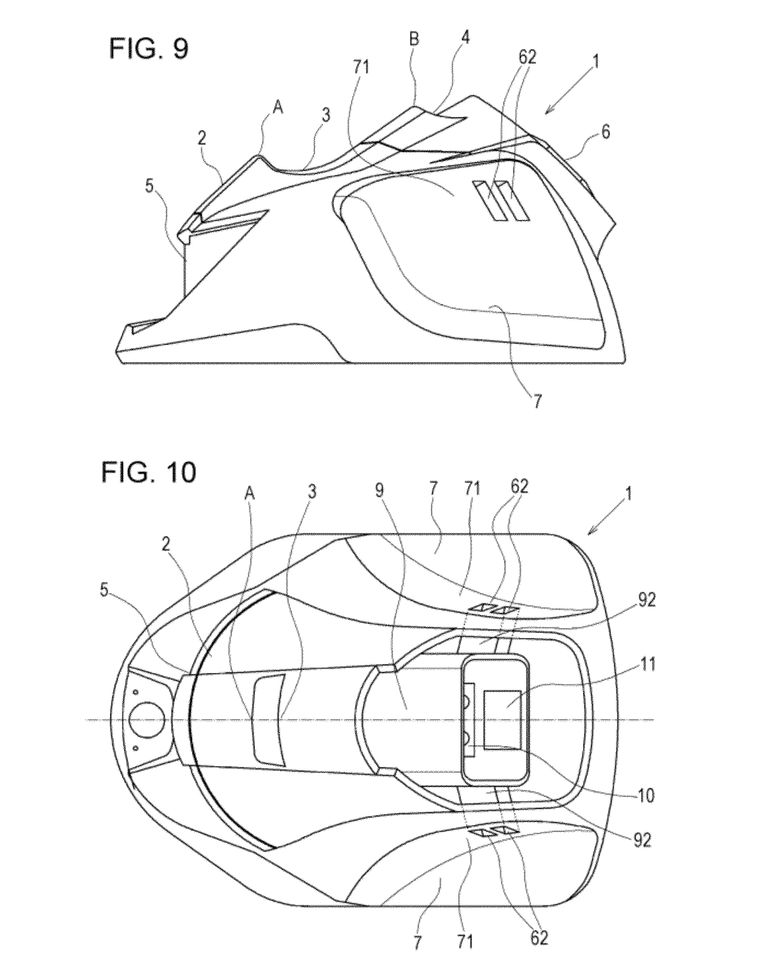

Referring to FIG. 9, the auxiliary air outlets 62 described above have openings in the recesses 7 (side walls 71). As illustrated in detail in FIG. 10, the auxiliary air outlets 62 are connected to branch passages 92, which branch out from the air duct 9, and ions are guided through the branch passages 92. These branch passages 92 are formed at positions downwind of the ion generating device 10. The auxiliary air outlets 62 are formed in upper parts of the recesses 7 and have vertically elongated shapes. This is for the purpose of preventing parts of the helmet from coming into contact with the openings of the auxiliary air outlets 62 and completely closing the openings.

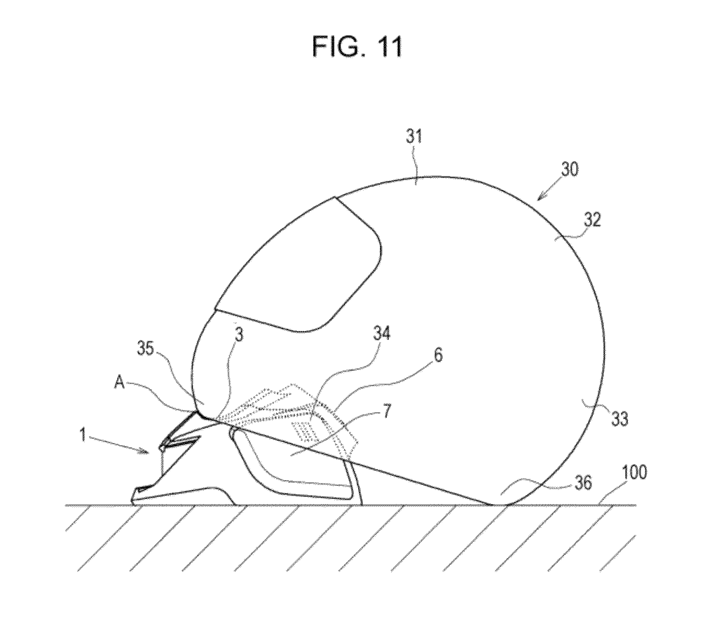

The ion generating apparatus 1 having the structure described above is placed on a placement surface, and the full face type helmet 30 is placed as illustrated in FIG. 11. This placement is the same as that illustrated in FIG. 8. As illustrated in FIG. 11, when the helmet 30 is placed while being positioned, the auxiliary air outlets 62 face the cheek pad sections 34. Therefore, generated ions are released straightly and directly toward the cheek pad sections 34.

Subsequently, the ion generating apparatus 1 can directly and directionally release ions not only toward the vicinity of the vertex section 32 but also toward the cheek pad sections 34 of the helmet 30. Therefore, the effects of deodorization, sterilization, and the like can be further increased. Additionally, a drying effect is also increased due to an airflow created by the blower 8.

### Third Embodiment

Next, another embodiment (a third embodiment) of the present invention will be described. Usually, helmets have shapes for protecting a head, and such shapes and the like of the helmets differ in accordance with, for example, the purposes of use. In the foregoing description, protective helmets, used, in particular, for riding a bicycle, a motorcycle, or the like, have been used as examples of the object. Other examples of the object include helmets that are used in the workplace such as on construction sites and the like. The outline of the housing 2 of the ion generating apparatus 1 according to the present embodiment is formed such that the ion generating apparatus 1 can have a specific positional relationship with any of such helmets once the helmet is placed thereon.

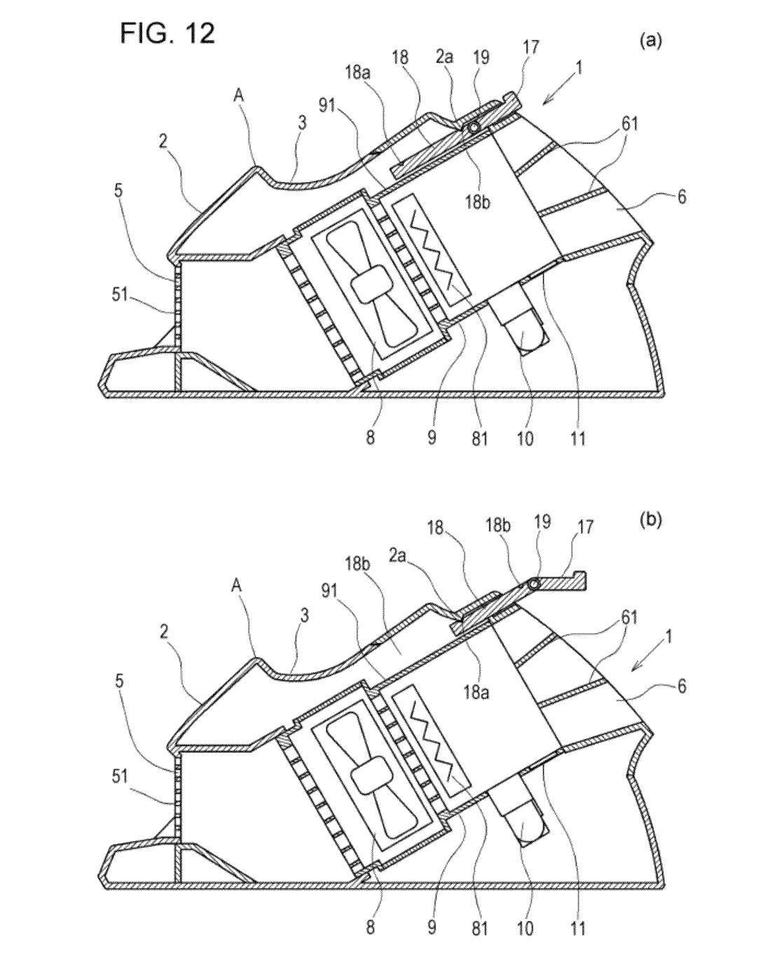

What is common in these helmets is that they have a chin strap for preventing the helmet from coming off a head. The presence of this chin strap makes it difficult to place the helmet on the ion generating apparatus 1. Moreover, a large amount of sweat and the like adhere to the chin strap. The third embodiment is the embodiment that can simultaneously and efficiently remove adhering odors of sweat and the like, and accordingly, the structure of the third embodiment referred to in FIG. 12 will be described in detail. The difference between the third embodiment and the first and second embodiments is the presence of a part related to a chin strap (an example of accessory parts of an object), wherein the other parts remain the same. Therefore, the same parts will be denoted by the same numerals and description of such parts will be omitted.

In FIG. 12, the housing, which forms the outline of the ion generating apparatus 1, has a part that can contain a hook portion 17 that is used to hang a chin strap thereon. This part is an air space formed above the air duct 9 and the air outlet 6, and the hook portion 17 is disposed in that air space. That is, the space is formed between an upper wall 91 of the air duct 9 and an inner wall of the housing 2 corresponding to the air duct 9.

A stick-shaped slide portion 18 is disposed in the air space so as to be slidable back and forth in the direction of airflow. The hook portion 17 is rotatably supported by a bearing portion 19 at an end of the slide portion 18. Notches 18a and 18b for positioning are formed on a side of the slide portion 18 that faces the housing 2. A protrusion 2a is formed on the housing 2 so as to face the notches 18a and 18b so that the protrusion 2a engages with the notches to fix and lock the slide portion 18 in place.

As the hook portion 17 is used to hang a chin strap thereon as described above, an end of the hook portion 17 opposite to the end at which the bearing portion 19 is located forms an L-shape that is bent upward.

Thus, when the hook portion 17 is not used, the hook portion 17 is pushed in and thereby the slide portion 18 slides leftward (forward) as illustrated in part (a) of FIG. 12 and retracts into the air space. At this time, the notch 18b of the slide portion 18 engages with the protrusion 2a on the housing 2 and becomes locked in place while being positioned. Only the L-shaped end portion for hanging a strap thereon protrudes, where the other parts of the hook portion 17 stay retracted.

When placing a helmet on the ion generating apparatus 1, the hook portion 17 is set up so that a chin strap can be hung on the hook portion 17 to prevent the chin strap from obstructing the placement of the helmet.

Next, the hook portion 17 is pulled rightward from the state illustrated in part (a) of FIG. 12. At this time, the notch 18b becomes disengaged from the protrusion 2a of the slide portion 18. Then, the protrusion 2a engages with the notch 18a of the slide portion 18 and fixed at a corresponding position, and this state is maintained. Thus, the hook portion 17 rotates around the bearing portion 19 and is retained in a state illustrated in part (b) of FIG. 12. However, although the hook portion 17 is rotatable, the rotation is structurally restrained at the position illustrated in part (b) of FIG. 12. This is easily achieved by using well-known structures and means.

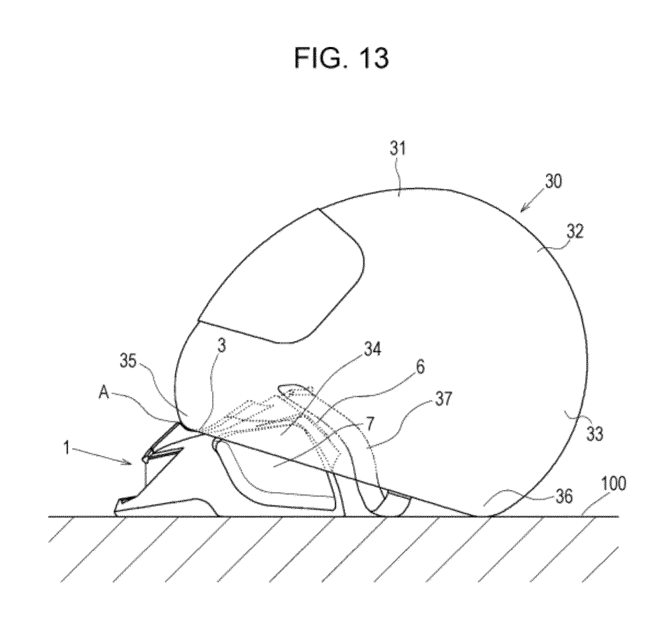

As described above, the hook portion 17 is retractably disposed in the housing 2. By pulling out the hook portion 17 and setting the hook portion 17 in a usable state illustrated in part (b) of FIG. 12, the helmet 20 can be placed while a chin strap 37 is hung on the hook portion 17 as illustrated in FIG. 13. Although a full face helmet illustrated in FIG. 8 is used as an example of a helmet herein, the same applies to other helmets.

When the helmet 30 has been placed as illustrated in FIG. 13, the ion generating apparatus 1 is operated, and ions are released into the inner space of the helmet as described above, so that a high concentration ion atmosphere can be created. At this time, free movement of the chin strap 37 is restrained, and therefore the air outlet 6 is not blocked and airflow is not obstructed. Moreover, the chin strap 37 is sterilized and deodorized by released ions and a drying effect can also be expected. Thus, effects same as those described in the first and second embodiments can be achieved with the present embodiment.

As necessary, the present embodiment may be provided with the auxiliary air outlets 62 as described in the second embodiment.

### (Other Examples of Use of Ion Generating Apparatus)

Examples of the use of the ion generating apparatus 1 for sterilizing and deodorizing an object have been described. In particular, in the examples described above, the object is a hat or a helmet, which does not lose its shape when being placed and that has an inner space.

However, in addition to such modes of use, the ion generating apparatus 1 can be used in other modes of use as well. The ion generating apparatus 1 described above allows an object to be placed thereon while maintaining a specific positional relationship with the object, however, the ion generating apparatus 1 can be still used independently.

In the ion generating apparatus 1, the air duct 9 between the blower 8 and the air outlet 6 is short and has a substantially linear shape. Therefore, the ion generating apparatus 1 can be made compact and portable. For the same reason, generated ions can be released in the direction in which the air duct 9 is inclined with no obstruction to the airflow in the air duct 9, so that the ions can be efficiently released to the outside space. Moreover, in the ion generating apparatus 1, the air passage that connects the air inlet 5 and the air outlet 6 is substantially linear, and the air duct 9 and the like are arranged in an upwardly inclined direction toward the air outlet 6. As a result, the ion generating apparatus 1 can emit generated ions in the upwardly inclined direction, so that the ions can be directionally released toward a target object.

For personal use, a user places the ion generating apparatus 1 on a flat surface of a table or the like when he returns home or on another occasion. When the user sits at the position, the air outlet 6 can be directed toward the head area of the user including the face. Then, the user switches the ion generating apparatus 1 on. Thus, ions are released toward the user's face, head, and hair, and thereby sweat and odors can be efficiently removed. As positive and negative ions are generated, ions are clustered with a large number of water molecules, so that moisturizing effect and the like can be expected with those water molecules.

The ion generating apparatus 1 can directionally emit ions into a user's mouth. Therefore, the ion generating apparatus 1 can also be used for gargling when the user returns home. Such a mode of use is effective in preventing the common cold and the like, as viruses, bacteria, and the like are sterilized and inactivated.

It is effective to provide the ion generating apparatus 1 according to the present embodiment with a heat source (that heats blown air) in order to shorten the time required for the ion generating apparatus 1 to achieve the effect of deodorizing and sterilizing of a helmet. FIG. 12 illustrates this example. In this case, the heat source is a heater 81 having, for example, a coil-like shape and disposed directly behind the blower 8. The heater 81 is disposed upwind of the ion generating device 10 and downwind of the blower 8 in the air duct 9. With the heater 81, the effect of removing water in sweat and the like can be increased with heat and the deodorization effect can also be increased. Also, the number of generated ions and the like is not significantly affected by the heater 81, and the ions can be released through the air outlet 6. An experiment was carried out in which positive and negative ions were emitted under the condition of 2 million/cm³ toward a piece of cloth having synthetic odors adhering thereto. According to the results of the experiment, the deodorizing effect achieved when ion emission was performed for about 1.5 hours by using an ion generating apparatus comprising a heater was substantially equivalent to that achieved when ion emission was performed for 4 hours by using an ion generating apparatus that did not comprise a heater.

### (Others)

As described above, the ion generating apparatus 1 according to the embodiments of the present invention includes a housing 2, which forms an exterior body; an air inlet 5, through which air is sucked in; an air outlet 6, through which the sucked-in air is blown out; a blower 8, which is disposed between the air inlet and the air outlet and blows the air; and an ion generating device 10, which generates ions, wherein the ions generated by the ion generating device 10 are released to the outside together with the air blown out by the blower 8. The housing 2 includes a positioning portion that is capable of specifically setting the positional relationship between the air outlet 6 and an object toward which the ions are emitted (the target of ion emission).

To be specific, the positioning portion includes a depression 3, which is formed in an upper part of the housing 2 and which allows a part of the object to be placed thereon. As illustrated in FIGS. 6 and 8, when an object is supported by the depression 3 and the placement surface 100 in a situation in which the ion generating apparatus 1 is placed on the substantially flat placement surface 100, the positional relationship between the object and the air outlet 6 is specifically set (the object is positioned in this way). Also, the air outlet 6 is configured to blow air toward the object, for which the positional relationship has been specifically set.

The positioning portion includes recesses 7, which are recessed inward on side walls of the housing 2 so as to be capable of specifically setting a positional relationship with the object. Thus, positioning of an object having a shape as illustrated in FIG. 6 or 8 can be more reliably performed, as well as positioning of an object having a shape illustrated in FIG. 7 can be performed.

As a result, the ion generating apparatus 1 can specifically set the positional relationship between the air outlet 6 and the object and can directionally release generated ions toward the object.

The ion generating apparatus 1 has such a shape that the orientation (position) of a helmet, which is an example of an object, when the helmet is placed, can be specifically set so that ions are directionally released and hit parts of the inside of the helmet to which odors and the like are most likely to adhere.

With the ion generating apparatus 1, the orientation of an object (such as a helmet) is specifically set when the object is placed on the ion generating apparatus 1 so the ion generating apparatus 1 can directionally emit ions toward parts of the object to which odors and sweat are particularly likely to adhere. According to this, the effect of removing adhering odors can be increased.

The ion generating apparatus 1 is configured to be capable of positioning an object, such as a helmet or a hat, in the vicinity of the ion generator so that ions can be efficiently emitted toward the object and to be capable of maintaining the positional relationship.

That is to say, the housing, which forms the outline (appearance) of the ion generating apparatus 1, is provided with a positioning portion with which the object can be retained at a predetermined position. The housing may be provided with only one positioning portion, or may be provided with a plurality of positioning portions so that different types of objects can be positioned.

Examples of an object include those that are wearable by a person, that do not lose its shape when being placed, and that have an inner space. Such an object is, for example, a hat, a helmet, or the like. By releasing ions into the inner space of the object, the ion concentration in the inner space can be increased to almost an incomparably higher level than the ion concentration in a room when an ion generating apparatus is used in the room.

By appropriately determining the shape of the housing, which forms the outline of the ion generating apparatus 1, with consideration of the type of the helmet, which is an object, deodorizing effect can also be achieved when a helmet of any type is used as the object.

Moreover, in the ion generating apparatus 1, the ion detector 11 is disposed downwind of an attachment surface of the ion generating device 10. As a result, generated ions can be monitored and ions can be reliably emitted.

Next, the ion generating apparatus 1 can also be used, for ordinary uses of an ion generating apparatus, i.e., removing airborne bacteria and viruses in a room, odors, and the like by using generated ions, from one hand, and, depending on circumstances, for directionally emitting ions toward an object such as a hat, a helmet, or the like, from the other.

Additionally, the ion generating apparatus 1 according to the second embodiment has the auxiliary air outlets 62 in parts of the housing 2 corresponding to those of the cheek pad sections of a helmet. As a result, a deodorization effect can be exerted on the cheek pad sections and temple sections of insides of the helmet while maintaining the position of the helmet.

Finally, the scope of the present invention is not limited to the embodiments of the present invention described above. The technical contents of the embodiments can be used in combination beyond the frameworks of the embodiments as long as they do not contradict each other.

### REFERENCE SIGNS LIST

1 ion generating apparatus
2 housing
3 depression (positioning portion)
5 air inlet
6 air outlet
62 auxiliary air outlet
7 recess (positioning portion)
8 blower
81 heater (heat source)
9 air duct
10 ion generating device
11 ion detector
20 helmet (open face)
30 helmet (full face)
A protrusion (positioning portion)

1. An ion generating apparatus comprising a housing that forms an exterior body, an air inlet through which air is sucked in, an air outlet through which the sucked-in air is blown out, a blower disposed between the air inlet and the air outlet and blowing the air, and an ion generating device that generates ions, the ions generated by the ion generating device being released to the outside together with the air blown out by the blower,
wherein the housing includes a positioning portion that is capable of specifically setting a positional relationship between the air outlet and an object toward which the ions are emitted.

2. The ion generating apparatus according to claim 1, wherein the positioning portion includes a depression that is formed in an upper part of the housing and that allows a part of the object to be placed thereon.

3. The ion generating apparatus according to claim 1, wherein the positioning portion includes a recess that is recessed inward on a side wall of the housing so as to be capable of specifically setting the positional relationship with the object.

4. The ion generating apparatus according to claim 3, wherein an auxiliary air outlet is formed in the recess.

5. The ion generating apparatus according to claim 1, wherein the housing includes an installable hook portion for placing an accessory part of the object thereon.

6. The ion generating apparatus according to claim 1, wherein a heat source for heating the blown air is disposed downwind of the blower and upwind of the ion generating device.

7. The ion generating apparatus according to claim 2, wherein the positional relationship is specifically set when the object is supported by the depression and a substantially flat placement surface in a situation in which the ion generating apparatus is placed on the substantially flat placement surface, and
wherein the air is blown out through the air outlet toward the object for which the positional relationship has been specifically set.

8. The ion generating apparatus according to claim 7, wherein the object is a helmet or a hat.

9. The ion generating apparatus according to claim 2, wherein the positioning portion includes a recess that is recessed inward on a side wall of the housing so as to be capable of specifically setting the positional relationship with the object.
